(19) United States
(12) Patent Application Publication
(10) Pub. No.: US 2010/0110670 A1
(43) Pub. Date: May 6, 2010

(54) Magnetically actuated flashlight

(76) Inventors: Samuel Werth, Indianapolis, IN (US); Thomas Killion, Indianapolis, IN (US)

Correspondence Address: INDIANO VAUGHAN LLP., SUITE 1300, ONE NORTH PENNSYLVANIA STREET, INDIANAPOLIS, IN, 46204, US

(21) Appl. No.: 12/590,186

(22) Filed: Nov. 4, 2009

Related U.S. Application Data
(60) Provisional application No. 61/198,342, filed on Nov. 5, 2008.

(51) Int. Cl. F21L 4/00

(52) U.S. Cl. 362/157

(57) ABSTRACT

A magnetically actuable flashlight includes a holder member and a light containing member. The holder member includes a first magnetic members, and the light containing member is capable of being selectively magnetically coupled to the holder member. The light containing member includes a housing, and a switch member contained within the housing. The switch member is movable between a switch on and a switch off position. A second magnetic members is coupled to the switch member. The second magnetic member is magnetically attractive to the first magnetic member for selectively magnetically coupling the holder member to the light containing member. A power source is coupled to the switch member and at least one light is selectively electrically coupled to the power source through the switch member. The magnetic coupling of the holder member and the light receiving member causes the second magnetic member to move the switch to the switch off position to electrically uncouple the at least one light and power source.

### I. PRIORITY

This application claims benefit to Werth and Killion, U.S. Provisional Patent Application, Ser. No. 61/198,342 filed 5 Nov. 2008, and titled Magnetically Actuated Flashlight, which is fully incorporated herein by reference.

### II. TECHNICAL FIELD OF THE INVENTION

The present invention relates to flashlights, and more particularly, to a flashlight having a magnetically actuated on and off switch.

### III. BACKGROUND OF THE INVENTION

Flashlights provide a user with an easily transportable source of illumination. To free the flashlight's movements from the constraints of power cords and/or generators, a flashlight employs a portable power source, such as one or more batteries, that are electrically coupled to an illumination device such as a conventional light bulb or an LED type bulb.

A housing that is sized to be easily transported houses the battery and the illumination device. The size of the housing is usually determined by the size and number of batteries that are to be used with the flashlight. A variety of mechanical switches exist one of which can be chosen to electrically couple the illumination device to the batteries to enable the user to turn the flashlight on and off.

Users prefer a flashlight that is convenient to use. As one never knows exactly when one will need a flashlight to illuminate a dark space, it is helpful to have a flashlight readily available, so that when one encounters darkness, one can use one's flashlight to illuminate the darkened area. For this reason, policemen will often carry a flashlight on their tool belts so that they have a flashlight close by at all times.

One difficulty with many flashlights is that they are inconveniently large and bulky. Size and bulk are often necessary because the flashlight housing must be large enough to hold batteries of a sufficient size and number to provide enough electrical energy to provide enough light over a long enough period of time to enable the user to perform her desired task. To provide this power, many flashlights employ a plurality of D-cell type batteries. However, certain times exist when only a smaller amount of light is necessary. On such occasions, it is helpful to have a smaller flashlight that takes up less space and can be more conveniently carried.

To that end, flashlights have been designed that are small and intended for use on key chains. Other flashlights are designed to have a size and shape similar to a pen. Examples of the varities of flashlights available are shown at Flashlights.com, which is owned by Flashlights, Inc.

A flashlight should also be designed for one-handled operation, so that the user's other hand is free to perform other tasks.

One object of the present invention is to provide such a small convenient flashlight that can be easily carried by a user, and can be single-handedly operated by a user, so that the user can take it from its holding place and quickly have the light turned on through a single-handed operation.

### IV. SUMMARY OF THE INVENTION

In accordance with the present invention, a magnetically actuable flashlight is provided that includes a holder member and a light containing member. The holder member includes a first magnetic member, and the light containing member is capable of being selectively magnetically coupled to the holder member. The light containing member includes a housing, and a switch contained within the housing. The switch is movable between a switch on and a switch off position. A second magnetic member is coupled to the switch member. The second magnetic member is magnetically attractive to the first magnetic member for selectively magnetically coupling the holder member to the light containing member. A power source is coupled to the switch and at least one light is selectively electrically coupled to the power source through the switch. The magnetic coupling of the holder member and the light receiving member causes the switch to move to the switch off position to electrically uncouple the at least one light and power source.

Preferably, the second magnetic member is coupled to the switch and the decoupling of the holder member and the light receiving member causes the switch to move in a switch on position to electrically couple the light to the power source. A biasing member can be provided for biasing the switch to a switch on position when the light containing member is uncoupled from the holder member. The expansive force exertable by the biasing member to move the switch to the switch on position should be less than the attractive force exerted by the first and second magnetic members when the holder member is coupled to the flashlight member, so that the second magnetic member moves the switch to the switch off position when the light containing member is coupled to the holder member.

In a preferred embodiment of the present invention, the light containing member includes a housing having a hollow interior, and a movable frame member disposed within the hollow interior. The switch member, magnetic member, power source member and light, are mounted to the movable frame member for movement between a generally proximal position when the light containing member and holder member are coupled together, and a generally distal position when the light containing member and holder member are not coupled to each other.

One feature of the present invention is that the holder member includes a magnetic member that interacts with a magnetic member contained within the light-containing flashlight member. The flashlight member magnetic member moves the flashlight's on-off switch from an “on” to an “off” position. The device is designed so that when the flashlight member is connected to the holder member, the magnetic members within the holder and the flashlight member interact to move the switch into a closed or off position to turn the lights “off”. However, when the light-containing flashlight member is disengaged from the holder member, the lack of magnetic interaction between the flashlight member and the holder member enables a biasing member in the flashlight member to move the switch into an open or “on” position.

This arrangement has the advantage of enabling the user to single-handedly turn on the flashlight by disconnecting the magnetic engagement between the flashlight member and the holder member. The disengagement allows the biasing member to move the switch to the “on” position to thereby turn on the flashlight. However, to carry around and store the flashlight member, the user can re-engage the flashlight member to the holder member in a single-handed operation. When re-engaged, the magnetic member within the holder member magnetically attracts the magnetic member of the flashlight member to move the switch member into an “off” direction, to thereby turn the light off. Although preferably the first and second magnetic members both comprise magnets, one of the first and second magnetic members can comprise a magnet, while the other of the first and second magnetic members comprises a magnetizable member, such as a piece of non-magnetic iron that is capable of being attracted by the magnet.

Additionally, the magnetic interaction between the flashlight magnet member and the holder magnet member magnetically couples the holder member to the flashlight member, so that the two members form a unitary joined member. As such, the engagement of the holder member to the flashlight member not only secures the flashlight member to the holder member, but also maintains the flashlight member in a flashlight off position.

Another feature of the present invention is that the design of the holder and flashlight is compact. This compactness enables the user to carry a small unobtrusive flashlight on his person that is always within easy reach. As such, the user can always have the flashlight with him, without being forced to carry around any significant additional weight. Through the magnetic interaction between the holder and the flashlight, the user can both remove the flashlight from the holder and turn it on in a single-handed operation. As the device does not require the user to actuate any sort of external switch, the light will turn on and off merely through a connection and disconnection between the flashlight member and the holder member, without requiring the user to fumble around with, and actuate an external switch.

A further feature of the present invention is that it can be designed to provide a powerful light that can be employed by the user to great advantage in a variety of situations. For example, a nurse can carry the flashlight around her neck on a lanyard. When entering a patient's dark room, she can actuate the flashlight to view the patient's chart, or look at the patient while only dispensing a small amount of directed light into the room. Through the use of only a small amount of light, directed away from the patient, the nurse reduces the likelihood of disturbing or waking up the patient. This feature is also useful for dorm directors, scout leaders, jail guards, resident assistants and parents who wish to check on sleeping children without risking waking persons up by turning on bright overhead lights.

It is also a feature of the present invention that the device uses LED light bulbs, that are carried upon the movable switch. As alluded to above, the switch is movable under the action of the magnetic interaction between the respective magnetic members carried by the flashlight member and the holder member.

The magnetic members attract strongly enough, so that when engaged, the force of the magnetic members can overcome the force of the spring biasing member. As such, when the magnetic members interact, they tend to bias the switch into a closed position, so that the switch moves in a direction toward the holder member, when the flashlight is engaged to the holder member. When the magnetic interaction between the flashlight and the holder member is lost, such as by the removal of the flashlight from the holder, the switch will move in an axially distal direction under the axially outwardly biasing force of the springs that are coupled to the switch. By moving the switch in an axially distal direction, the switch is moved to an “on” position wherein the circuit is completed between the batteries and lights, to turn the lights on and cause them to glow.

Additionally, as the lights are mounted to the movable switch, the axially distal movement of the switch causes axially distal movement of the LED lights. The lights are moved axially distally outwardly past the rim of the case of the flashlight holder. By so placing the LED light bulbs outside the case, the lights are better exposed to the outside environment. This exposure also makes the lights more visible from a variety of positions so that when the proximal end of the flashlight holder case rests upon a surface, such as a table leg, the axial distal movement of the LEDs to a position above the level of the rim of the case permits the light to be seen from 360 degrees or from all positions surrounding the light.

In contrast, when the magnets of the switch engage the magnets of the holder, the lights are retracted. Preferably, the lights are retracted so that the distal end of the LED light is disposed axially inwardly of the distal end of the flashlight case. When in this position, the LED lights are nested within the case, and are not sticking out the end, or otherwise extending past the distal end of the flashlight member case. When the lights are so nested, they are protected to some extent from damage caused by the end of the base hitting table tops, and the like. When the lights are sufficiently nested, dropping the flashlight onto a table would be less likely to damage the lights, since they are positioned within the casing of the flashlight.

This nesting is especially important when the light is used in situations that are more likely to give rise to rough treatment.

Another feature of the present invention is that includes a surface that is well designed for imprinting.

The present invention is believed to have great utility in the promotional products market. In order to improve its utility in that market and others, it is helpful for the invention to have a surface suitable for imprinting a message. For example, the radially outwardly facing ovoid cylindrical smooth surface is well suited for either the application of a decal or direct printing. Examples of “messages” that can be printed on such a surface include decorative messages, such as flags, mountain scene, flowers and the like for those who appreciate items of beauty. Alternately, a commercial message such as the selling store (e.g. Home Depot, Loew's), the tool company selling the product (e.g. Stanley, Kobalt, Snap-On) can be printed thereon not only to identify the source of the product, but to provide advertising for the product.

In the ad speciality (promotional products) industry, it is often the case that one wishes to imprint the name of a particular customer on the flashlight product (e.g. Joe's Printshop, Northside Dentistry and the like); or alternately, the name and/or logo of an advertised product (e.g. Bayer Asprin) or of an affinity product (e.g. Local City NHL Team or Wally World Amusement Park).

These and other features and advantages of the present invention will become apparent to those skilled in the art upon a review of the drawings and detailed description of various embodiments of the invention, that are perceived to represent the best mode of practicing the invention perceived presently by the Applicants.

### V. BRIEF DESCRIPTION OF DRAWINGS

FIG. 1 is a side view of a magnetically actuated flashlight 10A of the present invention in its joined position, wherein the flashlight member is coupled to the holder member;

FIG. 1A is a side view of another magnetically actuated flashlight, 10B of the present invention shown in the joined position;

FIG. 2 is a side view of a flashlight 10A of the present invention, similar to FIG. 1, except showing the device is its separated position, wherein the flashlight member is separated from the holder member;

FIG. 2A is a side view of flashlight 10B, also showing the device in the separated position;

FIG. 3 is a perspective, exploded view of the present invention taken from an upper perspective;

FIG. 4 is another perspective, exploded view similar to FIG. 3, except showing only the plastic parts;

FIG. 5 is a perspective exploded bottom oriented view of the present invention;

FIG. 6 is a sectional view taken along lines 6-6 of FIG. 1A; and

FIG. 7 is a sectional view taken along lines 7-7 of FIG. 2A.

### VI. DETAILED DESCRIPTION

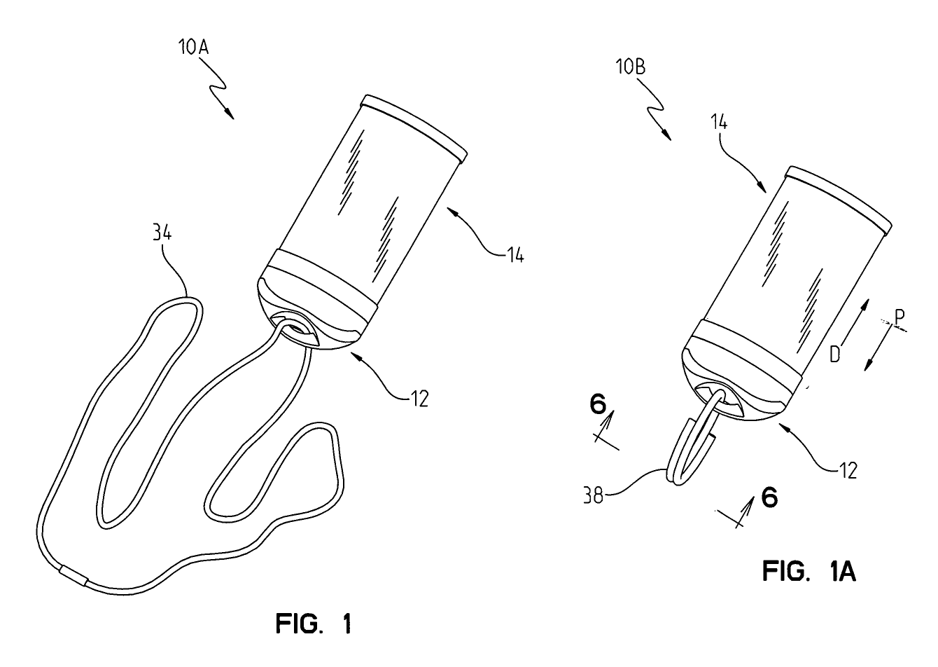

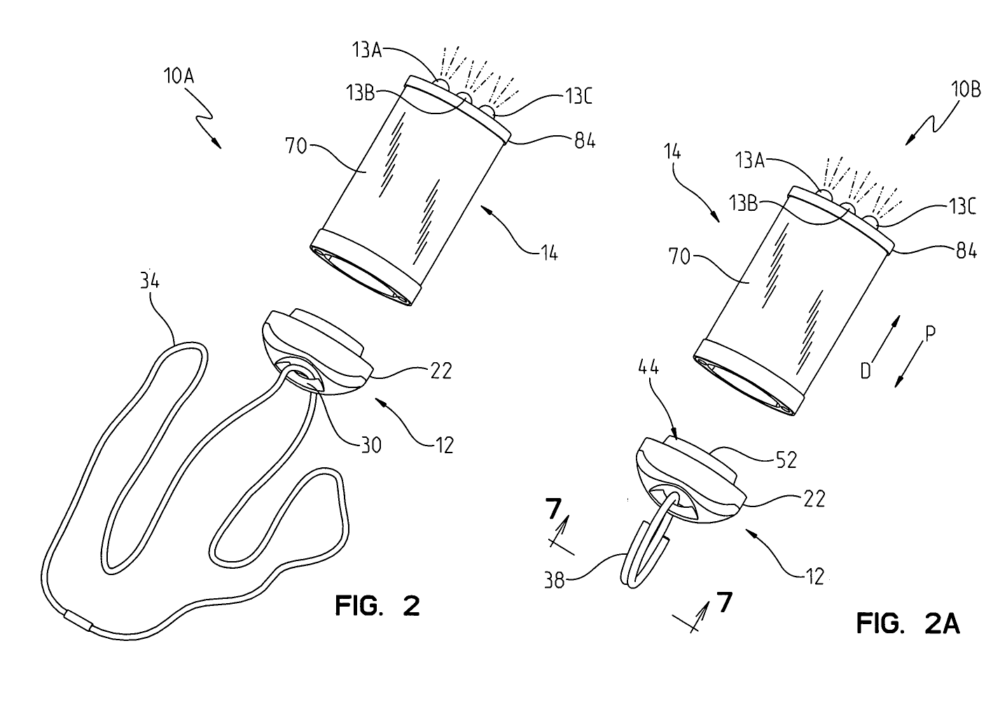

A pair of flashlights 10A, 10B are shown in FIGS. 1, 1A and 2, 2A. The various components of flashlights 10A and 10B are generally similar, and as such, identical part numbers (e.g. holder member 12) will be used for identical parts in both flashlights 10A, 10B, with differing numbers being used to point out differences. Additionally, the reference numeral 10 will be used to refer to the two flashlights 10A, 10B collectively.

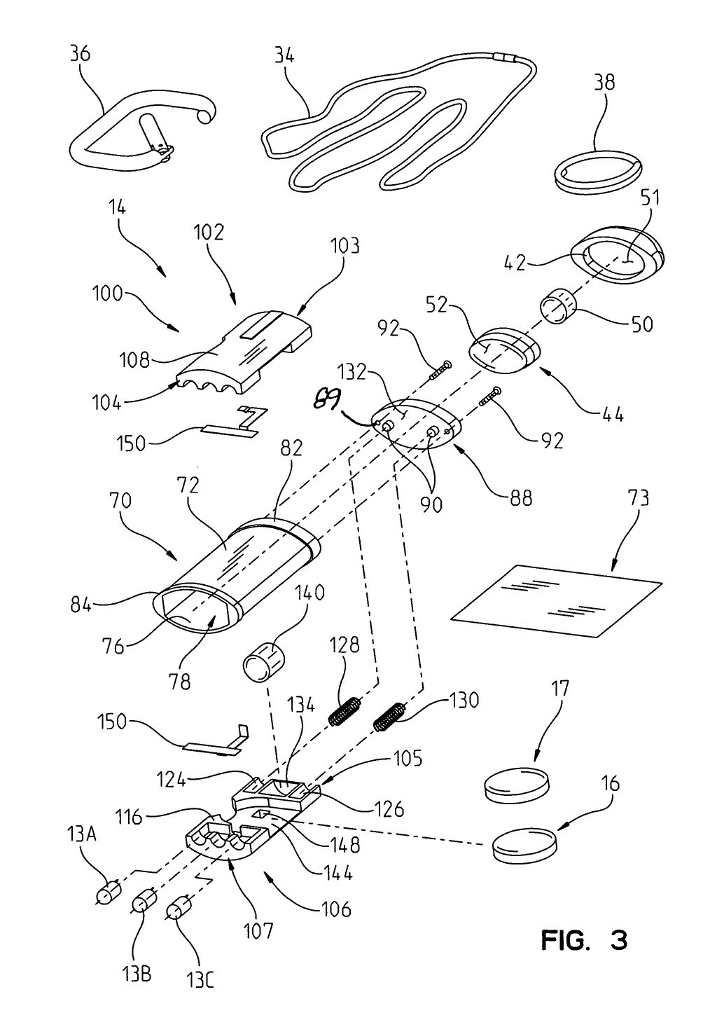

The flashlight device 10 of the present invention is shown in the figures as having two primary components. These two primary components include a base or holder member 12 and a flashlight member 14. The holder member 12 is designed to either include, or be coupled to an attachment member such as lanyard 34, carabineer 36, or key ring 38 (FIG. 3). The attachment member is designed to facilitate hands free transportation of the device 10. For example, lanyard 34 can be placed around the neck of the user, carabineer 36 can be coupled to a belt loop or back pack, and key ring 38 can be coupled to a set of keys. Other attachment members include such things as wrist bands, clip, pins, rubber bands, etc. In this regard, the readers attention is also directed to the applicant's co-pending patent application, Werth and Killion U.S. patent application Ser. No. 12/317,860, that was filed on 30 Dec. 2008, and which claims benefit to 61/018,481, filed 1 Jan. 2008, both of which are fully incorporated herein by reference.

The holder member 12 is selectively engagable with the flashlight member 14, so that the flashlight member 14 can be engaged and disengaged from the holder member 12. In order to use the flashlight member 12 as a flashlight, the user disconnects the flashlight member 14 from the holder member 12. When disconnected, the user holds the flashlight member 14 in her hand so that she can direct the light beam emanating from the lights 13A, 13B and 13C of the flashlight 14 to shine upon the object or thing that she wishes to illuminate.

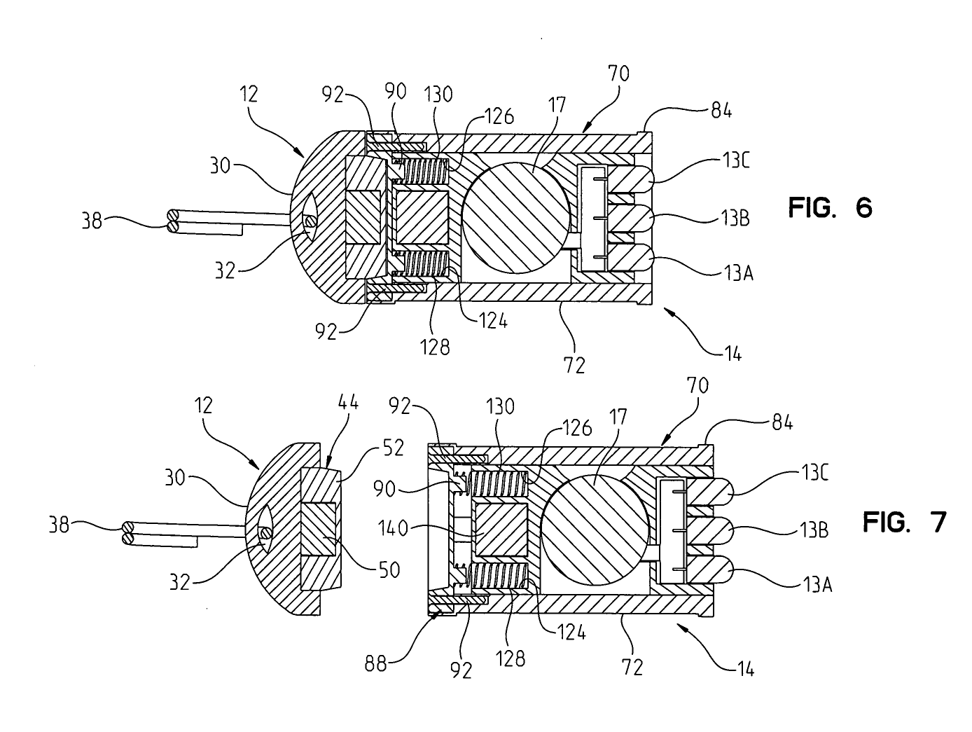

In FIGS. 1 and 6, the flashlight member 14 is shown as being engaged to the holder member 12. When the flashlight member 14 is engaged to the holder member 12, the device 10 is designed so that the lights 13A and 13B and 13C are turned off and not lit. As will be discussed in more detail below, current from the batteries 16, 17 is disconnected from the LED light, thereby causing the lights 13A, 13B, 13C to turn off and cease shining.

In contrast, when the flashlight member 14 is disconnected from the holder member 12 (FIGS. 1, 2, 2A and 7), a switch within the device 10 is actuated, so that current is supplied from the battery (shown in FIG. 3 as a pair of “watch-type” batteries 16, 17) to the lights 13a-13c so that the lights 13A-13C turn on and thereby glow, giving off a light beam.

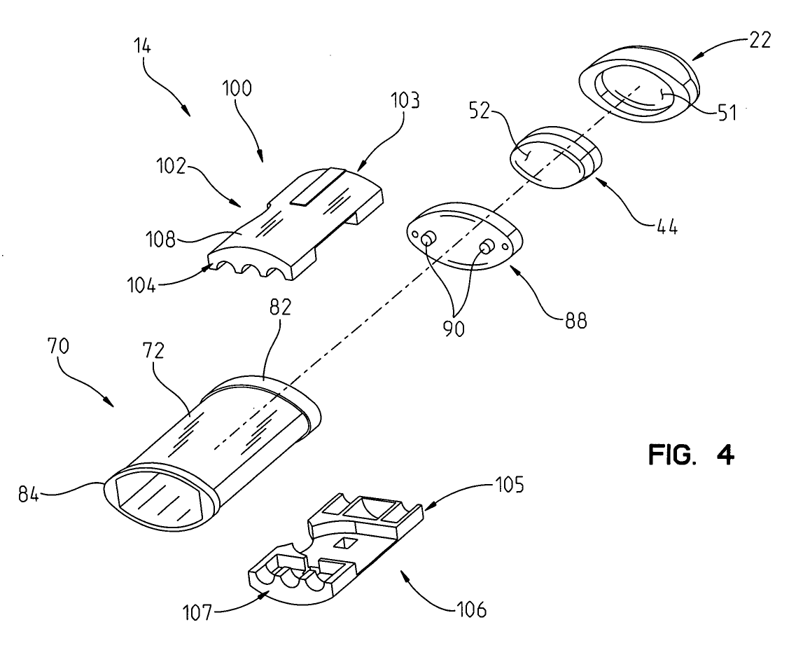

As best shown in FIGS. 3-5, the holder member 12 includes a housing 22, that is preferably made of plastic. However, in “heavier duty” and “ruggedized” models the holder 12 and flashlight member 14 housings can be made of a metal such as steel or aluminum. The replaceability of the batteries 16, 17, and the retractability of the lights 13A-13C enables the device 10 to be manufactured in a very rugged manner. As such, the replaceable batteries 16, 17 enable the device 10 to be used for an extended time, through the replacement of the batteries 16, 17 when they become discharged. The rugged design also increases the resistance of the device to breakage.

The holder housing 22 includes a proximal portion 24 and a distal portion 26. As used in this application, the directional term “proximal” will be used to indicate that portion of the device 10 (and its various components) that are closer to the lanyard 34. In contrast, the term “distal” will indicate a direction or device portion that is closer to the lights 13A-13C of the invention. It will be appreciated that these directions are arbitrary, and are provided for illustration and not limitation.

The proximal portion 24 of the holder member 12 includes a carved out area 28 that defines a diametral, centrally disposed, axially proximally extending upstanding spine 30. The upstanding, attachment member receiving spine 30 includes a radially extending aperture 32 through which an attachment member can pass. The attachment member can take one of a variety of forms. For example, one can pass a lanyard 34 through the aperture 32 to couple the lanyard 34 to the spine 30 of the holder housing 22 of the device 10. Such a lanyard 34 can be sized and configured to be placeable around the neck of the user, so that the user can carry the flashlight 10 around his neck in a manner similar to a necklace.

For other applications, one might wish to attach a carabineer 36 to the device 10. An appropriately sized carabineer 36 would be designed to pass through the aperture 32, so that for example, one could couple the carabineer 36 to the flashlight 10, and also couple the carabineer 36 to a belt loop (not shown). Another alternative is a key chain 38 that can be provided to pass through the aperture 32, so that the flashlight can be affixed to a user's key chain 38, along with a set of keys.

As best shown in FIGS. 3, 4, 6 and 7, the distal portion 26 of the holder member 12 includes an axially distally opening cavity 42 that is sized for receiving a magnetic member holder 44. The magnetic member holder 44 has a proximally opening blind cavity 48 that is sized and configured for receiving a magnetic member 50.

The magnetic member holder 44 also includes a solid axially distally facing surface 52. The magnetic member holder 44 and housing 22 are designed to overcome the inherent difficulties of bonding a magnet 50 to plastic. By placing the proximal opening cavity 48 on the proximal side of the magnetic member holder 44, and employing a solid distal surface 52, the magnetic member 50 is trapped within the cavity 48, and cannot move in a distal direction. Being plastic, the magnetic member holder 44 can be bonded to the plastic housing 22 with a glue or via sonic welding.

When this occurs, the opening of the magnet containing aperture 48 faces in a proximal direction. The proximal surface 49 of the magnetic member holder 44 is then butted up against the distal inner surface 51 of the housing, to thereby trap the magnetic member 50 therein. Without this arrangement, it is likely that any bond between the magnetic member 50 and the magnetic holder 44 would fail over time, causing the magnetic member 50 to separate from the magnetic member holder 44.

The flashlight member 14 is best shown in the figures as including a housing 70 that is generally cylindrical, elongated and ovoid in cross section. The flashlight member housing 70 includes an cylindrically ovoid outer surface 72, on which a message can be imprinted, or to which a decal 73 can be applied to impart a message. As shown in FIGS. 1 and 2, the message imprinted on the decal is limited only by the imagination of the user. Two examples of messages include a primarily decorative message such as the flag-like message as shown in flashlight 10B. Another category of message is a commercial message, such as the advertising-type message shown on housing 10A. The choice of what to imprint on the decal 73 or upon the surface 72 is left primarily to the imagination and desires of the user.

The housing 70 also includes an inner surface 76 that comprises a truncated ovoid in cross section. The truncated ovoid inner surface 76 defines a hollow interior 78 that extends between the proximal end lip 82, and a distal end lip 84 of the housing 70. A proximal end cap 88 includes a pair of apertures 89 through which fasteners, such as screws 92 can pass, for fixedly, but removably coupling the proximal end cap 88 to the housing 70 adjacent to the proximal end lip 82. The fasteners should be removable fasteners, such as screws 92, so that the user can remove the proximal end cap 88. One motivation for opening the proximal end cap 88 is to change batteries 16, 17 when the batteries that are originally provided with the device wear out. This ability to change batteries 16, 17 in the device helps to lengthen its useful life to thereby make the device more long lasting.

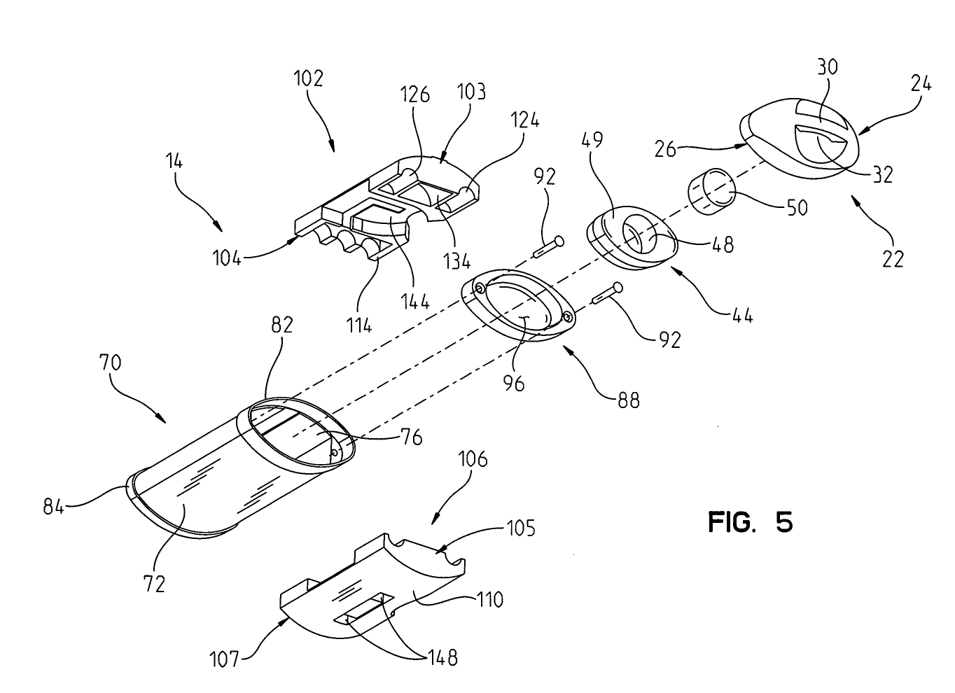

The proximal surface of the proximal end cap includes a recessed area 96 (FIG. 5). The recessed area 96 is provided for and sized for receiving the distal end portion adjacent to the distal end surface 52 of magnetic member housing 44 of the holder portion 12.

A multi-component light switch assembly 100 is disposed within the hollow interior 78 of the flashlight housing 70. The light switch assembly 100 includes a plurality of components, such as the lights 13A-13C, the switch, batteries 16, 17, biasing means for biasing the light and switch assembly 100 in an “ON” position, and a magnetic member for counteracting the distally directed D (FIG. 2A) bias caused by the spring 128, 130 of the light and switch assembly 100, to thereby move the light and switch assembly 100 in a proximal direction P (FIG. 2A), to thereby turn the switch in the “OFF” position, and turn the light 13A-13C off.

The light and switch assembly 100 is slideable in the interior between a generally proximally disposed position, as is shown in FIG. 1, and a distally disposed position as is shown in FIG. 2.

Although the light and switch assembly 100 is shown in neither FIG. 1 or 2, one can deduce from these drawings that the light and switch assembly 100 is in its proximal position in FIG. 1, because the lights do not appear to be exposed out of or extend distally past the distal end 84 of the housing 70. It will also be noted that the light and switch assembly 100 is in its relatively proximal or (lights off) position when the flashlight member 14 is coupled to the holder member 12, so that the lights and switch assembly 100 is magnetically retracted to the proximal or off position.

In contrast, the light and switch assembly 100 extends to its distal position when the holder 12 is separated from the flashlight member 14. When in the distal position, the switch member provides a current contact (via contact member 150) between the battery 16, 17 and the lights 13A-13C, to cause the lights 13A-13C to illuminate and otherwise be on, as shown in FIG. 2. Further, it will be noted that the movement of the light and switch assembly 100 into its distal position causes the distal ends of the light bulbs 13A-13C to extend beyond the distal lip 84 of the housing 70.

Returning back to FIGS. 3-5, the light and switch assembly 100 includes a first frame member 102, and a second frame member 106. In most respects, the first and second frame members 102, 106 are mirror images of each other, and are designed to be joinable to each other, so that, when joined, they can fit into the hollow interior 76 of the flashlight member housing 70. Preferably, the first and second frame members 102, 106 are sized and configured, so that when joined, they will form a slider that is slidably received within the interior 76 of the frame 70, so that the housing members 102, 106 can slide between their distal (lights on) and their proximal (lights off) position.

The first frame member 102 includes a proximal end 103 and a distal end 104. Similarly, the second frame member 106 includes a proximal end 105 and a distal end 107.

The first frame member 102 includes an outer surface 108, and the second frame member 106 includes an outer surface 110. Outer surfaces 108, 110 are sized and configured to generally conform to the interior wall surface 76 of the housing 70, to permit the first and second frame members 102, 106 to be received therein, and to permit the outer surfaces 108, 110 to slide easily against the inner surface 76, so that the frame members 102, 106 can slide between their proximal (switch off) position and their distal (switch on) position.

Each of the first and second frame members 102, 106 includes inner surfaces 114, 116, respectively. The inner surfaces 114, 116 each include a plurality of upstanding walls, that define a plurality of component containers for containing various components of the light and switch assembly 100.

These containers include first and second spring receiving cavities 124, 126 respectively, that are disposed at the generally proximal end 105, 103 of the housing members 106, 102 respectively. The first and second spring receiving cavities 124, 126 include open proximal ends, and are sized and positioned for receiving a pair of springs 128, 130. The proximal ends of the springs 128, 130 are designed to rest against a pair of cylindrical protrusion-like spring positioners 90, that extend axially distally from the distal surface 132 of proximal cap 88. As such, the distal surface 132 of the proximal end cap 88 serves as a proximal spring rest for the springs 128, 130. To help the alignment of the springs, the spring cavities 124, 126 can be positioned so that they align with and captured by the spring positioners 90 of the proximal end cap 88, so that the spring positioners 90, when inserted, pass through the center of the springs 128, 130, to help retain the springs within the cavities 128, 130 (See FIGS. 6 and 7).

A proximally disposed central magnetic member receiving cavity 134 is disposed between the first and second spring receiving cavities 124, 126. As the name suggests, the magnetic member receiving cavity 134 is disposed at the proximal end of the housing members 102, 106. The magnetic member receiving cavity 134 is sized and configured for receiving a magnetic member 140.

The springs 128, 130, and magnetic member 140 cooperate to move the frame members 102, 106 and hence the light and switch assembly 100 in its appropriate proximal P or distal D direction, depending upon what is desired. When the flashlight member 14 is coupled to the holder member 12, the attractive force between magnetic member 140 and magnetic member 50 overcomes the outwardly biasing force exerted by springs 128, 130. As such, the magnetic attraction between magnetic member 50 of the holder member 12 and magnetic member 140 of the body 14 causes the frame members 102, 106 of the light and switch assembly 100 to move in a generally proximal P direction, so that the proximal end 105, 103 of the frame members 102, 106 abuts the distally facing surface 132 of the end cap 88.

However, when the holder member 12 is separated from the flashlight member 14, magnetic attraction no longer exists between the magnetic member 50 of the holder member 12, and the magnetic member 140 of the light and switch assembly 100. As such, there is no magnetic attraction to overcome the expansive force exerted by springs 128, 130. Therefore, the springs 128, 130 expand against their proximal rest stop (the distal surface 132 of proximal end cap 88) and their distal rest stop (the radially extending walls at the proximal end of cavities 124, 126) to push or otherwise move the frame members 102, 106 in a distal direction as shown in FIGS. 2, 2A.

The frame members 102, 106 also include a central battery receiving cavity 144, that is sized and configured to receive appropriately-sized batteries. In the embodiment shown in the figures, the batteries 16, 17 comprise a pair of coin or hockey puck-shaped “watch-type” batteries 16, 17, of the type that one might use in a wristwatch, hearing aid, digital camera, garage door opener or any other application where size constraints suggest that cylindrical disc-shaped batteries 16, 17 work well.

The central battery cavity 144 of the second frame member 106 also includes an aperture 148, through which a contact 150 extends. Contact 150 is an electrical coupling with the batteries 16, 17. The electrical contact 150 can move between a circuit dis-connected position when the light and switch assembly 100 is in its proximally disposed or off position, and a circuit connected position when the light and switch assembly 100 is in its distal or lights on position. As shown in FIG. 1, the placement of the circuit in the dis-connected position causes the lights not to glow, as they receive no current. In contrast, when the light and switch assembly is placed in the distal position where the electrical contact 150 is in the connected or lights on position, the lights 13A, 13B, 13C will glow (FIG. 2) as they are receiving current from the batteries 16, 17 via the circuit and electrical contact 150.

First, second and third light receiving cavities 154, 157, 158 are disposed at the distal end of the frame members 102, 106. The first, second and third light receiving cavities 154, 156, 158 are configured for receiving three LED-type light devices, 13A, 13B and 13C.

In operation, one can begin in the configuration of the device shown in FIGS. 1 and 6, with the holder member 12 coupled to the light containing flashlight member 14 of the flashlight 10A, 10B. When in this position, the magnetic attraction between the magnetic member 50 of the holder member 12, and the magnetic member 140 of the light containing flashlight member 14 is such that the light and switch assembly 100 will be moved into its proximal or “lights off” position. When in the lights off position, the contact 150 of the circuit between the batteries 16, 17 and the lights 13A, 13B, 13C is disconnected, so that electrical energy from the batteries 16, 17 does not reach the lights 13A-13C. Therefore, the lights 13A-13C are placed in their off position. Additionally, since the light and switch assembly 100 is in its proximal position, the distal ends of the lights 13A-13C will be retracted within the interior 78 of the housing 70.

As shown in FIGS. 1 and 6, when so retracted, the lights 13A-13C cannot be seen from the side view, as they are nested within the interior 78 of the housing. When the holder member 12 is separated from the flashlight 14, (as shown in FIGS. 2 and 7) the attractive force between the magnetic members 50, 140 is reduced to an inconsequential level, due to the distance between the magnetic members 50, 140. In the absence of magnetic attraction, the outwardly biasing force exerted by the springs 128, 130 is allowed to move the light and switch assembly 100 into its distal position. When in the distal position, the switch and contact 150 is in its “completed circuit” position, so that electrical energy can flow from the batteries 16, 17 through the contact position 150 and circuit to the lights 13A-13C, to thereby turn the lights on, as shown in FIG. 2. As also shown in FIG. 2, the movement of the light and switch assembly 100 to its distal position enables the lights 13A-13C to extend axially outwardly beyond the distal lip 84 of the housing 70, so that the lights 13A-13C can better be seen from the side of the device.

The re-joinder of the flashlight member 14 to the holder member 12 reverses the process so that the proximally directed magnetic attraction between the magnetic member 140 of the flashlight member 14 and the magnetic member 50 of the holder member 12 overcomes the distally directed biasing force exerted by springs 128, 130, so that the light and switch assembly 100 moves into its proximal position, so that frame members 102, 106 are disposed adjacent to the distally facing surface 132 of the end cap 88. When so positioned, the circuit goes into its “disconnected” position, that causes the lights 13A-13C to shut off as no current can flow between the batteries and the light.

Although the invention has been described with reference to certain preferred embodiments, modifications and variations exist within the scope and spirit of the invention.

What is claimed:

1. A magnetically actuable flashlight comprising,
a holder member including a first magnetic member; and
a light containing member capable of being selectively magnetically coupled to the holder member, the light containing member including
a housing,
a switch member contained within the housing and movable between a switch on and a switch off position,
a second magnetic member magnetically attractive to the first magnetic member for selectively magnetically coupling the holder member to the light containing member,
a power source coupled to the switch member and
at least one light selectively electrically coupled to the power source through the switch member,
wherein the magnetic coupling of the holder member and the light receiving member causes the switch to move to the switch off position to electrically uncouple the at least one light and the power source.

2. The flashlight of claim 1 wherein the de-coupling of the holder member and the light containing member causes the switch to move to the switch on position to electrically couple the at least one light to the power source.

3. The flashlight of claim 2 further comprising a biasing member for biasing the switch to the switch on position when the light containing member is uncoupled to the holder member.

4. The flashlight of claim 3 wherein the magnetic coupling of the holder member and light receiving member causes the second magnetic member to move the switch to the switch off position, and wherein the first and second magnetic members are capable, when the light containing member and holder member are joined, of exerting an attractive force great enough to overcome the force exerted by the biasing member, to thereby move the switch to the switch off position when the holder member and the flashlight member are magnetically coupled together.

5. The flashlight of claim 2 wherein the power source comprises at least one battery and the biasing member comprises a spring.

6. The flashlight of claim 2 wherein the holder member includes a proximal portion and a distal portion, the proximal portion including an attachment member receiver for receiving an attachment member.

7. The flashlight of claim 2 wherein the attachment member receiver includes an aperture containing spine and the attachment member comprises at least one of a lanyard, rope, ring, and carabineer.

8. The flashlight of claim 6 wherein the distal portion of the holder member includes a magnetic member receiving cavity, and the first magnetic member is received in the magnetic member receiving cavity.

9. The flashlight of claim 6 wherein the holder member includes a magnetic member holder having a closed distal end and an open proximal end defining a magnetic member containing cavity for receiving the first magnetic member, wherein the magnetic member holder and holder member are both comprised of a plastic material, wherein the magnetic member holder and holder member are bonded together, and wherein at least one or the first and second magnetic members comprises a magnet and the other of the first and second magnetic members comprises a magnetizable member that is capable of being attracted by a magnet.

10. The flashlight of claim 1 wherein the light containing member includes a housing having a hollow interior, and a movable frame member disposed within the hollow interior.

11. The flashlight of claim 10 wherein the switch member and the second magnetic member are mounted to the movable frame member for movement between a generally proximal position when the light containing member and holder member are coupled together, and a generally distal position when the light containing member and holder member are not coupled to each other.

12. The flashlight of claim 10 wherein the housing of the light containing member includes an end wall disposed adjacent a proximal portion of the housing; and further comprising a biasing member extending between the end wall and movable frame member for exerting an expansive force to bias the frame member toward the distal portion.

13. The flashlight of claim 12 wherein the expansive force exerted by the biasing member is less than the attractive force exerted by the first and second magnetic members, to thereby cause the movable frame member to move into the generally proximal position where the holder member and the light containing member are coupled together.

14. The flashlight of claim 13 wherein the biasing member comprises a spring, the movable frame member includes at least one spring receiving cavity for receiving a distal portion of the spring, and the light comprises an LED type light.

15. The flashlight of claim 13 wherein the movable frame member includes a magnetic members receiving cavity for coupling the second magnetic members to the movable frame member, and a power source receiver for removably coupling a power source to the movable frame member.

16. The flashlight of claim 15 wherein the power source comprises a battery, the power source receiver comprises a battery receiver and the at least one light comprises at least two LED type lights.

17. The flashlight of claim 15 wherein the movable frame member includes a distal portion having at least one light receiving cavity for receiving the at least one light.

18. The flashlight of claim 10 wherein the movable frame member includes a proximal end and a distal end, the second magnetic members is coupled to the movable frame member adjacent to the proximal end, and the at least one light is coupled to the distal end of the movable frame member.

19. The flashlight of claim 18 wherein the light containing member includes a hollow interior having a proximal end and a distal end, the movable frame member is movable in the hollow interior between the switch off position wherein the movable frame member is disposed adjacent to the proximal end of the hollow interior, and the switch on position wherein the movable frame member is disposed adjacent to the distal end of the hollow interior.

20. The flashlight of claim 19 wherein, the at least one light includes a portion that is positioned distally of the distal end of the hollow interior where the movable frame member is positioned in the distal, switch on position.

21. The flashlight of claim 1 wherein the magnetic coupling of the holder member and the light receiving member causes the second magnetic member to move the switch to the switch off position.

22. The flashlight of claim 21 wherein the second magnetic member is coupled to the switch.
